(19) United States
(12) Patent Application Publication
(10) Pub. No.: US 2004/0223519 A1
(43) Pub. Date: Nov. 11, 2004

(54) Inverse multiplexing with mapping vector

(75) Inventors: Zeev Oster, Modiin (IL); Ariel Almog, Kochav Yair (IL)

Correspondence Address: DR. MARK FRIEDMAN LTD., C/o Bill Polkinghom, Discovery Dispatch, 9003 Florin Way, Upper Marlboro, MD, 20772, US

(73) Assignee: SPEDIANT SYSTEMS LTD.

(21) Appl. No.: 10/428,748

(22) Filed: May 5, 2003

(51) Int. Cl. H04J 3/04

(52) U.S. Cl. 370/536; 370/395.1

(57) ABSTRACT

An inverse multiplexing method for transmitting data via multiple data links and a system for implementing same. Efficient utilization of links having disparate data rates is provided by apportioning data units to the links in proportion to their data rates. Rather than perform the apportioning algorithm in real time, the algorithm is executed off-line, and the results recorded as a mapping vector. The mapping vector is used by the transmitter to apportion data units to the links, and by the receiver to re-assemble the data units.

### FIELD AND BACKGROUND OF THE INVENTION

The present invention relates to a system for inverse multiplexing data streams via multiple links, and more particularly to a system that apportions transmission of data units among links that may not all have the same data transmission rate, in such a way as to maximize data throughput and minimize data latency.

In an inverse multiplexing system, multiple data links are joined together in parallel to form a single aggregate link whose total data transmission capacity is close to or equal to the sum of the data transmission capacities of the individual links.

At the transmitter, an inverse multiplexing system must apportion the data stream into separate data streams, one for each of the links being used, while the receiver must recombine the several streams to recover the original data stream.

Several protocols for inverse multiplexing exist, including IMA (ATM), MLFR (Frame Relay) and MP (Network working group), which handle the transmission of ATM cells or packets from a single source to a single destination via multiple links.

In inverse multiplex systems there exists a need to decide, for each data unit, via which of the several links to transmit the data unit, and there exists a corresponding need for the receiver to be informed as to which data units are arriving on which links.

Protocols such as MLPPP and MLFR work with large data units, which allows time for the use of sophisticated algorithms to decide which link to use to transmit any particular data item. A disadvantage of this approach is that it requires large buffers and introduces significant delays in the transfer of data.

Another approach, which is used in IMA, is to transmit small data units. While this approach reduces buffer requirements and delay associated with the queueing of large data units, it has the disadvantage of making difficult and expensive the real time execution of a sophisticated algorithm for selecting the link on which to transmit each data unit. In the case of IMA, the algorithm used makes optimal use of total link capacity only if all of the links used have the same data rate. Thus, this approach is undesirable in inverse multiplex systems that utilize links that do not all have the same data rate.. See co-pending U.S. patent application Ser. No. 10/335872, which is incorporated by reference for all purposes as if fully set forth herein.

There is thus a widely recognized need for, and it would be highly advantageous to have, a system for inverse multiplexing data streams via multiple links that can utilize, during operation of the inverse multiplex system in real time, the results of a sophisticated algorithm for selecting via which link to transmit each data item, despite the algorithm requiring more time to execute than is available in real time.

### SUMMARY OF THE INVENTION

According to the present invention there is provided a system for transmitting data units via a plurality of communication links, each communication link having a respective link data transmission rate, the system including: (a) a transmitter including (i) an input port operative to receive data units; (ii) a plurality of output ports, each output port operative to transmit a respective portion of the data units via a respective communication link; and, (iii) a memory for storing a vector, the vector including a plurality of data link identifiers; wherein the transmitter is operative to transmit each data unit via a respective communication link chosen according to the plurality of data link identifiers.

According to the present invention there is further provided a method for transmitting data units via a plurality of communication links, each communication link having a respective link data transmission rate, the method including the steps of (a) providing a memory for storing a vector, the vector including a plurality of data link identifiers; and, (b) transmitting each data unit via a respective communication link chosen according to the plurality of data link identifiers.

Preferably, the transmitter is further operative to select from the vector, in a cyclical fashion, the data link identifiers.

Preferably, the transmitter further includes (iv) at least one buffer operative to store, in a first-in-first-out fashion, data units waiting to be transmitted via the communication links.

Preferably, the system further includes: (b) a receiver, for receiving the data units via the communication links, the receiver including: (i) a memory for storing a vector, the vector including a plurality of data link identifiers; wherein the receiver is operative to accept data units from each respective link according to indications, provided by the plurality of data link identifiers, of when data units are scheduled to be transmitted.

Preferably, the receiver is further operative to select from the vector, in a cyclical fashion, the data link identifiers.

Preferably, the receiver further includes at least one buffer operative to store, in a first-in-first-out fashion, data units arriving via the communication links.

Preferably, the vector included in the transmitter matches the vector included in the receiver.

Preferably, the method includes the further step of (c) selecting from the vector, in a cyclical fashion, the data link identifiers.

Preferably, the method includes the further steps of (c) receiving the data units from the communication links; and, (d) reassembling the data units in an order corresponding to the plurality of data link identifiers.

Preferably, according to the method of the present invention, the transmitting and the receiving are each performed according to matching sequences of the data link identifiers.

To balance the load on the links, it is preferred that the vector include a number of entries for each link proportional to the data rate of that link.

### BRIEF DESCRIPTION OF THE DRAWINGS

The invention is herein described, by way of example only, with reference to the accompanying drawings, wherein:

FIG. 1 is a schematic illustration of an inverse multiplex communication system according to the present invention;

FIG. 2 is a schematic illustration of the transmission and reception of a sample message using an inverse multiplex communication system according to the present invention.

### DESCRIPTION OF THE PREFERRED EMBODIMENTS

The present invention is of an inverse multiplexing system that can be used to transmit a single data stream via multiple links, making optimal use of the available transmission capacity and using a pre-computed mapping vector to aid in the selection of links for transmission of data units in real time and with minimal overhead.

The principles and operation of an inverse multiplexing system according to the present invention may be better understood with reference to the drawings and the accompanying description.

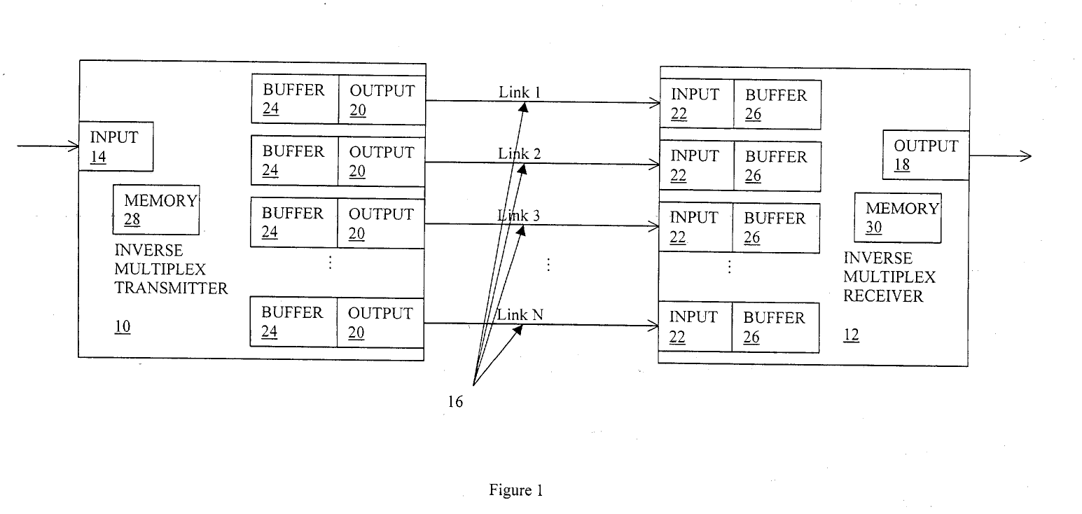

Referring now to the drawings, FIG. 1 illustrates a preferred embodiment of fan inverse multiplexing system according to the present invention. A stream of data units is presented to an inverse multiplex transmitter 10 by means of a transmitter input port 14. Inverse multiplex transmitter 10 apportions, in a manner described below, via a plurality of respective first-in-first-out (FIFO) buffers 24, incoming data units among a plurality of transmitter output ports 20 operative to send these data units via corresponding links 16. Receiver input ports 22 of an inverse multiplex receiver 12 accept data units from links 16, placing the data units in FIFO buffers 26, and inverse multiplex receiver 12 takes these data units from FIFO buffers 26 and reassembles these data units, as described below, and presents the reassembled stream of data units to a receiver output port 18.

Transmitter 10 uses a memory 28 to store a mapping vector that indicates which link 16 is to be used to transmit each data unit. Receiver 12 uses a memory 30 to store a mapping vector that matches the mapping vector in memory 28 of transmitter 10, the mapping vectors matching in the sense that both vectors produce the same sequence of indications of which link 16 each of a sequence of data items is transmitted on. The mapping vector of receiver 12 indicates which link 16 each data unit is transmitted on, so that receiver 12 is able to reassemble the data stream in the original sequence.

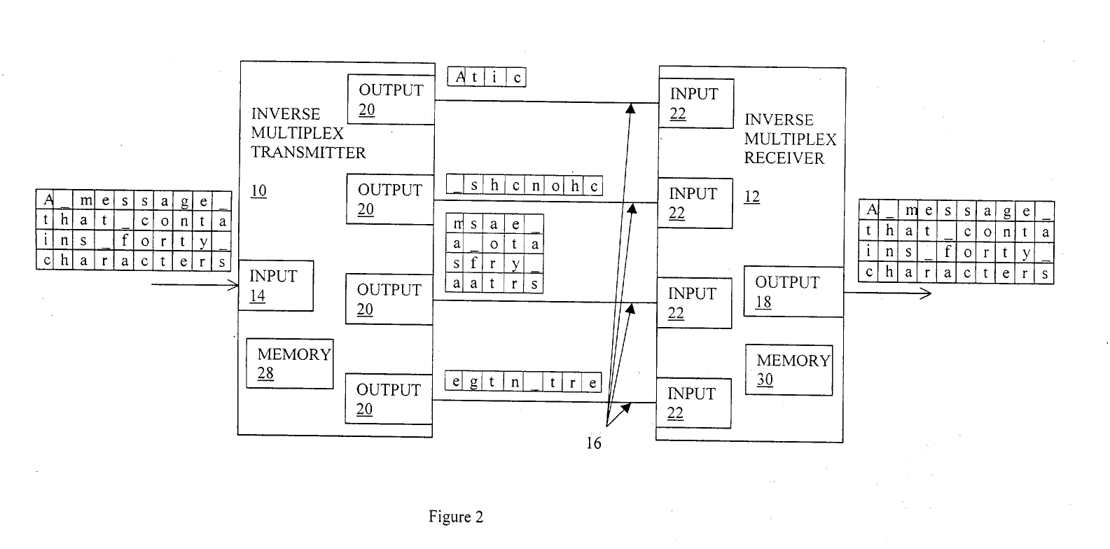

Referring now to FIG. 2, an inverse multiplex system having links 16 with unequal data rates is taken as an example. In this illustrative case, there are four links 16, the first link 16 having an arbitrary link data rate, and the second, third and fourth links 16 having respective data rates of two, five, and two times the link data rate of the first link 16. For clarity, FIG. 2 does not show the FIFO buffers 24, 26 associated with transmitter outputs 20 and receiver inputs 22. Respective links 16 provide transmission pathways between corresponding transmitter output ports 20 of transmitter 10 and corresponding receiver input ports 22 of receiver 12. In this illustration, a data unit is a single letter or character, such as “a” or “_”

In a system where individual links 16 do not all have the same transmission rate, it is not efficient simply to apportion the data units of the input stream of data units on a round-robin basis, i.e., in a system with N transmitter output ports 20 operative to send data units via N corresponding links 16, send the first data unit to the first link 16 via the first transmitter output port 20, send the second data unit to the second link 16 via the second transmitter output port 20, etc., with the Nth data unit going to the Nth link 16 via the Nth transmitter output port 20, the N+1th data unit going to the first link 16 via the first transmitter output port 20, and so on. Such a round-robin distribution would tend to overrun the data transmission capacities of the slower links 16, while the faster links 16 might remain idle for a substantial portion of the time.

In the system of this example, the steady-state data transmission rate of the system when using a round-robin distribution is only four times the data rate of the first link 16, significantly worse than the performance of the third link 16 operating alone. The second, third and fourth links 16 are all limited to the data rate of the first, and slowest, link 16. The second, third and fourth links 16 thus operate at only one half, one fifth, and one half of their respective capacities. Buffering in the transmitter 10 does not help significantly in the steady state, because the buffer for the first link 16 quickly fills to capacity, limiting the system. Buffering in the receiver 12 also does not help significantly in the steady state, because the buffer of the third and fastest link 16 quickly fills to capacity, limiting the system.

Because round-robin apportionment of data units to links 16 is not efficient where the links 16 have unequal data rates, it is desirable to use other apportionment algorithms. However, the real-time computational cost of implementing a sophisticated apportionment algorithm is greater than that of a round-robin. In the present invention, this problem is solved by the use of a mapping vector.

Because the data rates of the links 16 of this illustrative case are not all the same, it is desirable to match the data transmission load of each respective link 16 to its respective data transmission capacity. Thus, during the time that the first link 16 is to transmit a single data unit, it is desirable for the second and fourth links 16 to each transmit two data units, and for the third link 16 to transmit five data units.

One possible transmission schedule that meets this requirement is shown in the example of a mapping vector in Table 1. Each element of the mapping vector contains a single indication of which link 16 to use for the transmission of the current data unit. The mapping vector used by the transmitter is stored in memory 28. Because it is desirable that each link 16 carry a data load proportional to the data rate of that link 16, thus maximizing the total throughput of the system, it is preferred that the number of elements for each link 16 in the mapping vector be substantially in proportion to the data rate of that link 16. Application of this idea is readily apparent in Table 1, where there is one entry for the first link 16, two entries each for the second and fourth links 16, and five entries for the third link 16, in proportion to the data rates of those links 16.

Table 2 shows schematically the way the present example of the present invention transmits the illustrative message “A_message_that_contains_forty_characters”. In Table 2, each column represents, in sequence, a single data unit, and the apportionment of that data unit to a particular link 16 is indicated by the corresponding character appearing in the row corresponding to that particular link 16. The apportionment of data units to links 16 in Table 2 is in accordance with the mapping vector shown in Table 1. Thus, in the present example, the first data unit is transmitted via the first link 16, the second data unit is transmitted via the second link 16, the third data unit is transmitted via the third link 16, the fourth data unit is transmitted via the fourth link 16, the fifth data unit is transmitted via the third link 16, the sixth data unit is transmitted via the second link 16, the seventh data unit is transmitted via the third link 16, the eighth data unit is transmitted via the fourth link 16, the ninth data unit is transmitted via the third link 16, and the tenth data unit is transmitted via the third link 16. With the transmission of the tenth data unit, the mapping vector is exhausted, and the mapping vector is re-used, in a cyclical manner. Thus, the eleventh data unit is transmitted via the first link 16, the twelfth data unit is transmitted via the second link 16, and so on, until the twentieth data unit is transmitted via the third link 16, and the mapping vector is again re-used, so that the twenty-first data unit is transmitted via the first link 16, and so on.

Receiver 12, using the mapping vector stored in memory 30 as a guide, reassembles the data units into the original data stream.

Table 3 illustrates the efficient apportionment by the present invention of data units to the links 16. In Table 3, each row represents a particular link 16, while each column represents a single time slot, each time slot being half the time the third, and fastest link 16 takes to transmit a single data unit. In the time it takes the first link 16 to transmit a single data unit, the second and fourth links 16 each transmit two characters, and the third link 16 transmits five characters. Thus, each link 16 operates at its capacity, and the steady-state buffer utilization of each link 16 is finite, and in proportion to the data rate of the link 16.

Because the mapping vector is computed off-line, before the links 16 are used for transmission of payload data, there are no real-time constraints on the complexity of the algorithm used for preparing the mapping vector. During data transmission, the inverse multiplex transmitter 10 need only perform the relatively simple operation of cycling through the mapping vector stored in memory 28 to apportion each data unit to the appropriate link 16. Similarly, the inverse multiplex receiver 12 uses a mapping vector, stored in memory 30, that matches the mapping vector stored in memory 28 of transmitter 10, matching in the sense that both vectors produce the same sequence of indications of which link 16 each of a sequence of data items is transmitted on. This matching mapping vector of receiver 12 indicates which link 16 each data unit is transmitted on, so that receiver 12 is able to reassemble the data units appearing at inputs 22 in the original sequence.

FIFO buffers 24 of transmitter 10 allow transmitter 10 to prepare data units for transmission while earlier data units await transmission by links 16. FIFO buffers 26 of receiver 12 allow inputs 22 of receiver 12 to accept data units from links 16 while data units received earlier await processing by receiver 12.

TABLE 1
1
2
3
4
3
2
3
4
3
3

TABLE 2

| | Data unit number | | | | | | | | | |
|---|---|---|---|---|---|---|---|---|---|---|
| Link number | 1 | 2 | 3 | 4 | 5 | 6 | 7 | 8 | 9 | 10 |
| 1 | A | | | | | | | | | |
| 2 | | — | | | | s | | | | |
| 3 | | | m | | s | | a | | e | — |
| 4 | | | | e | | | | g | | |
| Link number | 11 | 12 | 13 | 14 | 15 | 16 | 17 | 18 | 19 | 20 |
| 1 | t | | | | | | | | | |
| 2 | | h | | | | c | | | | |
| 3 | | | a | | — | | o | | t | a |
| 4 | | | | t | | | | n | | |
| Link number | 21 | 22 | 23 | 24 | 25 | 26 | 27 | 28 | 29 | 30 |
| 1 | i | | | | | | | | | |
| 2 | | n | | | | o | | | | |
| 3 | | | s | | f | | r | | y | — |
| 4 | | | | — | | | | t | | |
| Link number | 31 | 32 | 33 | 34 | 35 | 36 | 37 | 38 | 39 | 40 |
| 1 | c | | | | | | | | | |
| 2 | | h | | | | c | | | | |
| 3 | | | a | | a | | t | | r | s |
| 4 | | | | r | | | | e | | |

TABLE 3

| | Time slot | | | | | | | | | |
|---|---|---|---|---|---|---|---|---|---|---|
| Link number | 1 | 2 | 3 | 4 | 5 | 6 | 7 | 8 | 9 | 10 |
| 1 | A | | | | | | | | | |
| 2 | — | | | | | s | | | | |
| 3 | m | | s | | a | | e | | — | |
| 4 | e | | | | | g | | | | |
| Link number | 11 | 12 | 13 | 14 | 15 | 16 | 17 | 18 | 19 | 20 |
| 1 | t | | | | | | | | | |
| 2 | h | | | | | c | | | | |
| 3 | a | | — | | o | | t | | a | |
| 4 | t | | | | | n | | | | |
| Link number | 21 | 22 | 23 | 24 | 25 | 26 | 27 | 28 | 29 | 30 |
| 1 | i | | | | | | | | | |
| 2 | n | | | | | o | | | | |
| 3 | s | | f | | r | | y | | — | |
| 4 | — | | | | | t | | | | |
| Link number | 31 | 32 | 33 | 34 | 35 | 36 | 37 | 38 | 39 | 40 |
| 1 | c | | | | | | | | | |
| 2 | h | | | | | c | | | | |
| 3 | a | | a | | t | | r | | s | |
| 4 | r | | | | | e | | | | |

While the invention has been described as having links that do not all have the same link symbol transmission rate, it will be appreciated that the invention is also applicable to situations where all links have the same link symbol transmission rate.

While the invention has been described with respect to a limited number of embodiments, it will be appreciated that many variations, modifications and other applications of the invention may be made.

What is claimed is:

1. A system for transmitting data units via a plurality of communication links, each communication link having a respective link data transmission rate, the system comprising:
(a) a transmitter including
(i) an input port operative to receive data units;
(ii) a plurality of output ports, each said output port operative to transmit a respective portion of the data units via a respective communication link; and,
(iii) a memory for storing a vector, said vector including a plurality of data link identifiers;
wherein said transmitter is operative to transmit each data unit via a respective communication link chosen according to said plurality of data link identifiers.

2. The system of claim 1, wherein said transmitter is further operative to select from said vector, in a cyclical fashion, said data link identifiers.

3. The system of claim 1, wherein said transmitter further includes
(iv) at least one buffer operative to store, in a first-in-first-out fashion, data units waiting to be transmitted via the communication links.

4. The system of claim 1, further comprising:
(b) a receiver, for receiving the data units via the communication links, said receiver including:
(i) a memory for storing a vector, said vector including a plurality of data link identifiers;
wherein said receiver is operative to accept data units from each respective link according to indications, provided by said plurality of data link identifiers, of when data units are scheduled to be transmitted.

5. The system of claim 4, wherein said receiver is further operative to select from said vector, in a cyclical fashion, said data link identifiers.

6. The system of claim 4, wherein said receiver further includes at least one buffer operative to store, in a first-in-first-out fashion, data units arriving via the communication links.

7. The system of claim 4, wherein said vector included in said transmitter matches said vector included in said receiver.

8. A method for transmitting data units via a plurality of communication links, each communication link having a respective link data transmission rate, the method comprising the steps of
(a) providing a memory for storing a vector, said vector including a plurality of data link identifiers; and,
(b) transmitting each data unit via a respective communication link chosen according to said plurality of data link identifiers.

9. The method of claim 8, comprising the further step of
(c) selecting from said vector, in a cyclical fashion, said data link identifiers.

10. The method of claim 8, comprising the further steps of
(c) receiving the data units from the communication links; and,
(d) reassembling the data units in an order corresponding to said plurality of data link identifiers.

11. The method of claim 10, wherein said transmitting and said receiving are each performed according to matching sequences of said data link identifiers.
